(19) United States
(12) Patent Application Publication
(10) Pub. No.: US 2006/0288112 A1
(43) Pub. Date: Dec. 21, 2006

(54) System and methods for storing music selections in network storage and for streaming the selections to a wireless device for playback on the wireless device

(75) Inventors: Emily Lyons Soelberg, Atlanta, GA (US); Justin M. McNamara, Atlanta, GA (US)

Correspondence Address: GARDNER GROFF SANTOS & GREENWALD, P.C., 2018 POWERS FERRY ROAD, SUITE 800, ATLANTA, GA, 30339, US

(73) Assignee: Cingular Wireless, LLC

(21) Appl. No.: 11/137,318

(22) Filed: May 25, 2005

(51) Int. Cl. G06F 15/16

(52) U.S. Cl. 709/231

(57) ABSTRACT

A system and methods for storing music selections in network storage and for streaming the music selections to a wireless device for playback on the wireless device. The system comprises a media storage database for storing music selections in a network, request receiving logic configured to receive a request sent by a wireless device, selection retrieving logic configured to retrieve music selections from the media storage database, and music streaming logic configured to stream a music selection retrieved from the storage element to a wireless device that sent a request to play the music selection to the system.

### TECHNICAL FIELD OF THE INVENTION

The invention relates to wireless technology. More particularly, the invention relates to a system in which music selections are stored in a network component and streamed upon request to a wireless device of a subscriber of a music service for playback on the wireless device.

### BACKGROUND OF THE INVENTION

Recently, music players that use MPEG-1 Part 3 Layer 3 or ISO/IEC 11172-3 Layer 3 (mp3) technology, such as the various versions of Apple iPods offered by Apple Computers, Inc., have become extremely popular. The iPod music player has a relatively large amount of memory to enable a relatively large number of music selections (e.g., thousands of songs) to be stored in the device.

In order to store music selections in an iPod music player, the user first downloads the music selections to the user's computer from a website via an Internet connection. The user then connects the user's iPod music player to a universal serial bus (USB) port of the computer and uploads the selections from the hard disk of the computer to the iPod music player. Alternatively, the selections can be uploaded to the iPod music player from compact disks (CDs) owned by the user.

Once the songs are stored in the iPod music player, the user can select “playlists” that contain lists of songs that they want to hear from the available songs. To do this, the user uses a user interface to make the desired selections.

One of the disadvantages of the iPod music player is that the user cannot download the selections wirelessly. Rather, the user must first download the selections to a hard disk of a computer from the Internet via an Internet connection and then upload the selections to the iPod music player using a USB interface. In addition, because copies of the songs are stored in the memory of the iPod music player, the user must purchase the songs.

Yahoo!, Inc. provides a service that allows users who pay a monthly fee to access a playlist of songs that the user can download to a computer that is connected to the Internet. The user may connect a wireless device to an input/output (I/O) port of the computer to have songs copied to the memory of the wireless device from the memory of the computer. The monthly fee is in exchange for obtaining limited-rights versions of the songs. One of the disadvantages of this service is that the user cannot download the songs wirelessly. Another disadvantage is that the user must purchase limited digital rights because copies of the songs are downloaded and stored in the computer's memory.

Some wireless providers have begun offering mp3 playback capability in wireless telephones. This makes it possible to wirelessly download songs to the memory of the wireless telephone from the Internet or from a computer.

One disadvantage of current techniques of using wireless telephones with mp3 playback capability to download and play back music is that the songs are stored in memory inside of the wireless telephone. Because copies of the songs are made, the songs must be purchased by the user. In addition, because wireless telephones have relatively small memory capacity, only a small number of songs can be stored in the memory of the wireless telephone. Consequently, the use of wireless telephones to store and playback music selections is not seen as a competitive alternative to the iPod music player or similar types of mp3 music players.

A need exists for a method and apparatus that enable music selections to be wirelessly transmitted to a wireless device so that they can be played back by the wireless device without having to be stored in the wireless device.

### SUMMARY OF THE INVENTION

The invention provides a system and methods for storing music selections in network storage and for streaming the music selections to a wireless device for playback on the wireless device. The system comprises a media storage database for storing music selections in a network, request receiving logic configured to receive a request sent by a wireless device, selection retrieving logic configured to retrieve music selections from the media storage database, and music streaming logic configured to stream a music selection retrieved from the storage element to a wireless device that sent a request to play the music selection to the system.

The method of the invention comprises receiving a request to play a music selection in a component of the network, determining whether or not the request is associated with a subscriber, and, if a determination is made that the request is associated with a subscriber, retrieving the requested music selection from the network media storage database and streaming the retrieved music selection to the wireless device that originated the request.

The invention also provides a computer program that controls the process of storing music selections in a media storage database of the network and of streaming music selections to wireless devices of users upon request. The computer program is embodied on a computer-readable medium and comprises a first code segment that receives a request to play a music selection in a component of the network, a second code segment that authenticates the request, and a third code segment that causes, if authentication is successful, a request to be sent to the network media storage database to retrieve the requested music selection and stream the retrieved music selection to the wireless device that originated the request.

These and other features and advantages of the invention will become apparent to those skilled in the art from the following description, drawings and claims.

### BRIEF DESCRIPTION OF THE DRAWINGS

FIG. 1 illustrates a block diagram of the wireless device of the invention and the system of the invention for enabling music selections to be selected by and streamed to the wireless device for playback on the wireless device.

FIG. 2 illustrates a flow chart that represents the method of the invention in accordance with an embodiment for playing one or more music selections on the wireless device that are streamed from a network to the wireless device.

FIG. 3 illustrates a flow chart that represents the method of the invention in accordance with an embodiment for creating a playlist.

FIG. 4 illustrates a block diagram of the wireless device of the invention and the system of the invention, wherein the application server shown in FIG. 1 further includes functionality for receiving and processing fan alerts.

FIG. 5 illustrates a flow chart that represents the method of the invention in accordance with another embodiment for sending, receiving and responding to fan alerts via communications between a wireless device and the network shown in FIG. 4.

### DETAILED DESCRIPTION OF THE PREFERRED EMBODIMENT

The present invention provides a wireless device that is capable of playing back music selections in a manner similar to the manner in which mp3 music players, such as the Apple iPod, for example, play back music selections. However, unlike mp3 music players, which store music selections locally in the memory of the music player, the wireless device of the invention has functionality that enables it to request music selections that are stored in network storage, which will then be streamed to the wireless device by a network streaming server. As the wireless device receives the streaming audio music selection, the wireless device plays the selection. Preferably the wireless device never stores a copy of the music selection, although it may buffer bits of the audio stream as needed to enable playback of the selection.

One of the advantages of the invention is that play back of the music selection is ephemeral in that once it is played, it is gone, and thus cannot be copied or shared. Another advantage is that the wireless device does not need to have a large amount of memory in order to play back music selections. One of the reasons that wireless telephones have not been used to store music selections for play back is that wireless telephones typically do not have sufficient memory to store a large number of music selections. In accordance with the invention, a subscriber's music selections are stored in a network storage element rather than locally in the memory element of the wireless device. Yet another advantage of the invention is that the user can select a music selection for playback on the user's wireless device on the fly, i.e., without having to be tethered to a computer, as is the case with the aforementioned service provided by Yahoo!, Inc.

The wireless device of the invention includes logic that is configured to enable the subscriber to interact with the network via the user's wireless device to set up a playlist that comprises music selections that the subscriber wants to listen to at some point in time. However, the selections are not downloaded to the subscriber's wireless device. The selections are stored in network storage rather than in the local memory of the wireless device. After the subscriber has set up the playlist, the subscriber makes a selection on the user interface of the wireless device to cause the music selections on the playlist to be played. The music selections on the playlist are streamed to the wireless device from a streaming server of the network. The wireless device includes functionality that enables the wireless device to play back the music selections as they are streamed to the wireless device.

In accordance with one embodiment of the invention, the user pays a subscription fee for the music service that allows the user to set up a playlist comprising one or more music selections, which are streamed from a streaming server of the network to the user's wireless device. In accordance with this embodiment, it is unnecessary for the user to purchase the digital rights for the music selections to which the user desired to listen. The network simply checks a database to determine whether the user is authorized to use the service, i.e., whether the user has a paid subscription to the music service. An authorization algorithm makes this determination. If the authentication process is successful, the music selections on the user's playlist are streamed to the user.

In accordance with another embodiment of the invention, a user of a wireless device purchases digital license keys for music selections over a network, such as, for example, the Internet. Websites currently exist that allow users to purchase license keys for music selections. The license keys of the music selections are downloaded to the user's wireless device where they are stored locally in the memory of the wireless device. The license keys that the user has purchased are also sent to a user storage database. The music selections themselves are not downloaded to the user's wireless device. Rather, the music selections are stored in a media storage database of the network.

Subsequently, when the user's wireless device sends the user's playlist to the network to be played, an authorization algorithm is executed that determines whether the music selections on the playlist match the music selections stored in the user storage database for the user. Essentially, the playlist includes the license keys and the algorithm determines whether the license keys on the playlist have matches in the user storage database location associated with the user. If the algorithm determines that the license keys on the playlist match the license keys stored in the user storage database for the user, then the playlist and the identity of the wireless device to which the music selections are to be streamed are forwarded to a streaming server. The streaming server then streams the selections on the playlist to the wireless device associated with the playlist.

Various types of license keys can currently be purchased. One type of license key is used to unlock an audio stream. If this type of license key is used with the invention, then the music selections on the playlist that are streamed to the user's wireless device will only be played back by the streaming player of the wireless device if the keys have previously been downloaded to the wireless device. Since the keys have previously been stored in the local memory of the wireless device, they will be available to unlock the stream received by the wireless device from the streaming server. However, using the license keys in this manner is not necessary since an authorization algorithm has already been performed prior to the streaming server streaming the music selections to the user's wireless device. Using the license keys in this manner may eliminate the need to perform the authorization algorithm at the network level since it is essentially performed at the wireless device.

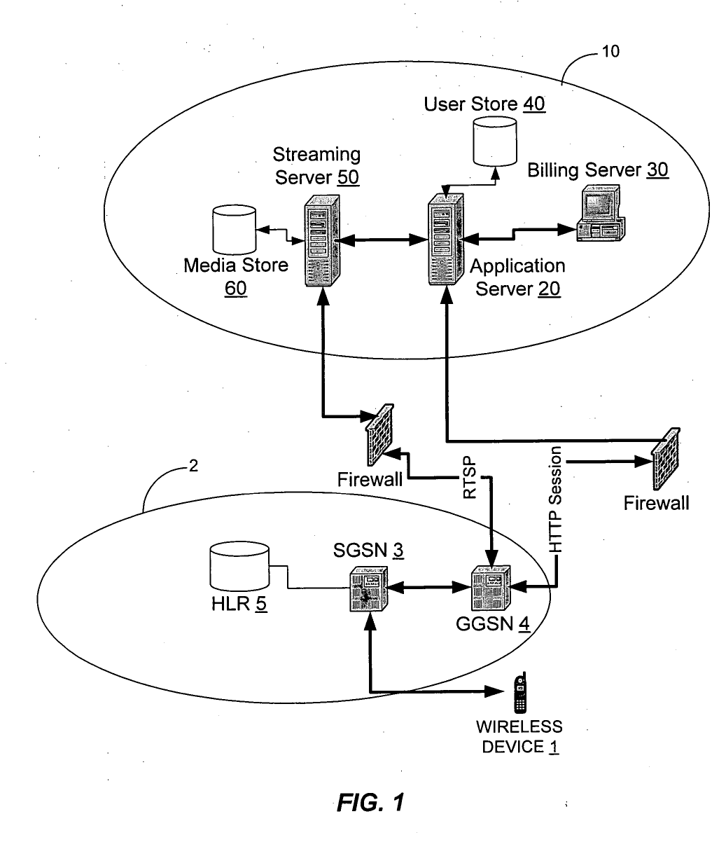

FIG. 1 illustrates a block diagram of the wireless device 1 of the invention and the system 10 of the invention for enabling music selections to be selected wirelessly and streamed to the wireless device 1 for play back on the wireless device 1. The wireless device 1 may be any type of wireless device having the functionality for playing back streaming audio. Because one of the advantages of the invention is that it enables a user to wirelessly create a playlist comprising a plurality of music selections and to play back the music selections without the need for storing them in local memory on the wireless device, the wireless device 10 may be a wireless telephone of the type that has only a small amount of local memory. Such telephones typically would not be capable of storing in local memory a large number of musical selections.

The manner in which the wireless device 1 and system 10 of the invention operate in accordance with an embodiment will now be described with reference to FIG. 1. The system 10 may comprise components that are connected to a public network such as the Internet or it may comprise components of a private network. Typically, all of the system components that communicate with each other have Internet Protocol (IP) addresses, regardless of whether they are connected to the Internet or to a private network.

In order to set up a playlist, modify a playlist, or make a selection from a playlist, a user initiates a session with a wireless packet-switched network 2, which is typically a General Packet Radio Services (GPRS) network, but may be any type of packet-switched network. A Serving GPRS Support Node (SGSN) 3 performs tunneling and detunneling of Internet Protocol packets and mobility management functions. A Gateway GPRS Support Node (GGSN) 4 detunnels data packets received from the SGSN 3 and routes them to an application server 20 of the system 10. The packets are sent from the GGSN 4 to the application server 20 in a Hypertext Transfer Protocol (HTTP) session using Transmission Control Protocol/Internet Protocol (TCP/IP). The application server has an IP address to which the GGSN 4 sends the packets.

The application server 20 performs an authentication algorithm to determine whether the user has a subscription for the music service and/or to determine whether or not the user has purchased the license keys associated with the music selections listed on the user's playlist. Because the user does not ever actually download (i.e., make copies of) music selections to the user's wireless device, it may not be necessary for the user to purchase digital rights (i.e., obtain license keys) to play each of the individual selections listed on the playlist. Rather, the provider of the music service (e.g., the owner of the network 10) may purchase the digital rights to music selections and charge subscribers a fee to use the service. In this case, the authentication algorithm need only verify that the user has subscribed to the service. The application server 20 may query a billing server 30 for user authentication and paid subscriptions.

Once it is determined that the user is a paid subscriber (or has purchased the digital rights), the application server 20 sends the playlist and the identity of the user's wireless device to the streaming server 50. The streaming server 50 then retrieves the selections listed on the playlist, assembles them into a real-time data stream and streams them to the user's wireless device 1.

In the case where the user rather than the music service provider purchases the digital rights, or license keys, to play music selections, the application server 20, upon receiving the user's playlist from the wireless device 1, performs authentication by checking a user storage database to determine whether the user has purchased rights to play the selections that are listed on the playlist. If the application server 20 determines that the user has purchased rights to play the selections listed on the playlist, the application server 20 sends the playlist and the identity of the user's wireless device to the streaming server 50. The streaming server 50 then retrieves the selections listed on the playlist, assembles them into a real-time data stream and streams them to the user's wireless device 1.

The invention also provides the potential to leverage existing products and services offered by others. For example, currently, users are able to purchase music selections from online stores such as, for example, Apple Computer's iTunes website on the Internet. With such online stores, a user purchases the digital rights to music selections, which are then downloaded to the user's computer via an Internet connection. The provider or owner of the system 10 of the invention could have an arrangement with such an online music store that would allow users who have purchased and downloaded music selections from an online store to have them played back on another device belonging to the user, such as a wireless telephone. In this exemplary case, the authentication process described above would typically also include determining whether the user has purchased iTune rights to selections listed on the user's playlist. If so, the corresponding selection would be streamed by the streaming server 50 to a wireless device designated by the user.

A similar feature could be provided for television programs and movies. Some companies currently provide customers with the ability to download television programs and movies or have them streamed over high-speed data networks to a computer or television at the user's premises. The provider or owner of the system 10 could have an agreement with such a company that would allow a user who has purchased such rights or permissions to also stream the movies or television programs to a wireless device designated by the user. In this exemplary case, the authentication process described above would typically include determining whether the user has purchased rights or permission for the movie or television programs included on the user's playlist. If so, the corresponding selection on the playlist would be streamed by the streaming server 50 to a wireless device designated by the user.

It should be noted that although the FIG. 1 illustrates particular network components 20, 30, 40, 50 and 60 for performing particular functions, these functions can be performed by a variety of logical configurations. For example, it is not necessary that separate servers be used to perform the functions described as being performed by the application server 20 and the streaming server 50. A single server could be used to perform all of these functions. Similarly, the functions described as being performed by the application server 20 and by the billing server 30 could be performed by the same server.

Each of the network components 20-60 comprises logic configured to perform certain functions, which is typically a processor programmed with software. For example, the application server 20 comprises logic configured to receive a request to play a music selection sent by the wireless device 1 to the network. Similarly, the streaming server 50 comprises logic configured to retrieve a music selection from the media storage database 60 and logic configured to stream the music selection to the wireless device 1 for playback on the wireless device 1. Similarly, the billing server 30 comprises logic configured to verify that a request was sent by a wireless device associated with a subscriber of the music service of the invention. The invention is not limited with respect to where these logical configurations are located and the manner in which they are implemented.

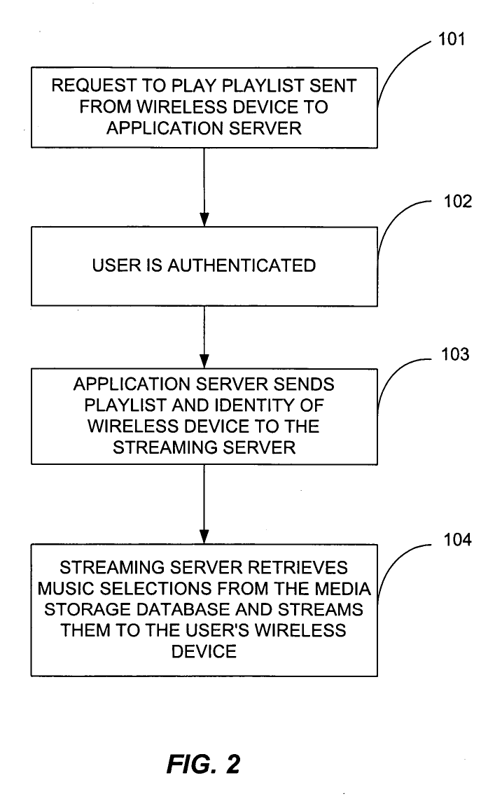

FIG. 2 illustrates a flow chart that represents the method of the invention in accordance with an embodiment for playing a music selection on the wireless device 1. Once the user has created a playlist, the user makes a selection on the user's wireless device that causes a request to play the playlist to be sent wirelessly from the wireless device 1 to the application server 20 via the wireless network 2, as indicated by block 101. The application server 20 then performs authentication by verifying that the user has purchased rights to play the selections listed on the playlist or by determining that the user has paid a subscription fee, as indicated by block 102. Assuming that authentication is successful, the application server 20 then sends the playlist and the identity of the wireless device 1, which is typically the International Mobile Subscriber Identity (IMSI), to a streaming server 50, as indicated by block 103. The application server 20 also returns a successful response to the wireless device 1 and opens a Real Time Streaming Protocol (RTSP) session with the streaming server 50. The streaming server 50 then retrieves the music selections listed on the playlist from a media storage database 60 and streams the selections to the wireless device 1 via the wireless network 2, as indicated by block 104. The streaming server 50 can use description information in the RTSP message to determine the audio or video coder/decoder (CODEC) that is best suited to the wireless device that is attempting to playback the streamed selection.

The wireless device 1 has a streaming player that enables the wireless device 1 to play back the streamed music selections. Because the manner in which audio is streamed and played back are well known, the features of the networks 2 and 10 and of the wireless device 1 that enable these tasks to be performed will not be described herein.

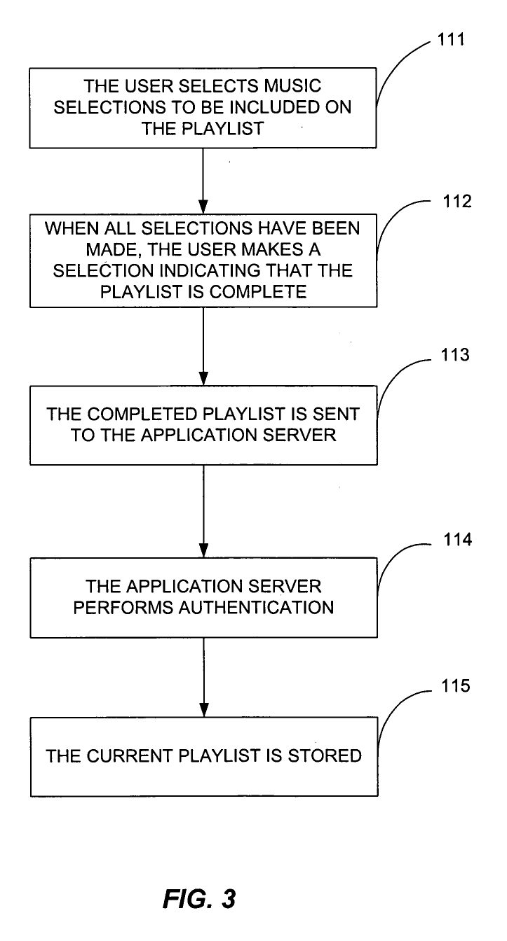

FIG. 3 illustrates a flowchart that represents the method of the invention in accordance with an embodiment for creating a playlist. The wireless device 1 preferably runs a microbrowser software program that enables web pages to be displayed on the wireless device 1. Via interaction with the microbrowser program, the user is provided with the ability to search a database, such as, for example, user storage database 40, using search criteria such as genre, artist, etc., for titles. The user makes selections via an input device (e.g., a keypad) of the wireless device 1 to add selections to the user's playlist, as indicated by block 111. When the user has finished creating the playlist, the user makes a selection by, for example, selecting a “Playlist Complete” button or icon, as indicated by block 112. The completed playlist is then sent to the application server 20, as indicated by block 113.

As described above, the application server 20 may perform an authentication or verification process when it receives the completed playlist to determine whether or not the user is authorized to use the service, as indicated by block 114. This may be accomplished by querying the billing server 30 to determine whether or not the user associated with the playlist is a paid subscriber. However, the authentication process may instead be performed when the user first attempts to create a playlist, such as when the user attempts to search the user storage database 40 for music selections to place on the playlist. The invention is not limited with respect to the location or time at which authentication is performed.

Once the playlist has been created and the user has been authenticated, the application server 20 may save the playlist in the user storage database 40 so that the user may use the playlist at a later time, as indicated by block 115. This step is optional, but preferred.

The display device of the wireless device 1 may display a “Play Current Playlist” button or icon to the user that the user selects when the user is ready to hear the selections on the playlist. When the user makes this selection, a request to play the user's current playlist is sent by the wireless device 1 to the application server 20. The application server 20 then sends the user's current playlist and the identity (e.g., IMSI) of the user's wireless device 1 to the streaming server 50, which then retrieves the selections on the playlist. The application server 20 then returns a successful response to the wireless device 1, which opens an RTSP session with the streaming server 50. The streaming server 50 streams the selections to the user's wireless device 1.

The display device 1 of the wireless device 1 may also display “Stop” and “Resume” buttons or icons that the user can select to halt and resume play, respectively. Requests associated with these selections will then be sent to the application server 20, which will then cause the corresponding action to occur via interaction with the streaming server 50.

As stated above, the current playlist may be stored locally in the memory of the wireless device and/or in the user storage database 40. If it is stored locally, then the user makes a selection on the display of the wireless device to cause the current playlist to be retrieved from local memory and displayed. If the current playlist is not stored locally, but is stored in the network, the user sends a request to the application server 20 for the playlist. The application server 20 responds by sending the current playlist to the wireless device 1.

When the current playlist is displayed on the display of the wireless device 1, the wireless device 1 preferably will display a list of options to the user to enable the user to modify the playlist. To add a music selection to the playlist, the user may search this list using search terms such as genre, artist name, etc. When a user finds a selection that the user wants to add to the user's playlist, the user simply makes a selection on the wireless device. The application server 20 receives the request and adds the music selection to the user's playlist. Fees may be charged by the billing server 30 when selections are added to the playlist. Alternatively, the user may purchase and download license keys for the selections being added to the playlist, in which case the license keys for the new selections would also be stored in the user storage database 40 at a location associated with the user.

In order to remove a music selection from the playlist, the user simply makes the appropriate selection using the input device of the wireless device 1. When the user makes the selection, the wireless device 1 forwards a request to the application server 20 to remove the particular music selection from the user's playlist. The application server 20 retrieves the user's playlist from the user storage database 40 and deletes the selection from the playlist. The wireless device deletes the selection from local memory. The application server 20 then saves the modified playlist in the user storage database 40. The billing server 30 may reimburse the user for fees that were previously charged to the user's account for music selections that are subsequently removed from the user's playlist.

The invention also provides users with the ability to share playlists. For example, a user could publish his or her playlist on a website on the Internet for others to access. Users other than the user who published the playlist could download it to his or her wireless device and subsequently upload the playlist to the application server 20 in the manner described above. The authentication and billing processes would be performed when the playlist is uploaded to the application server 20.

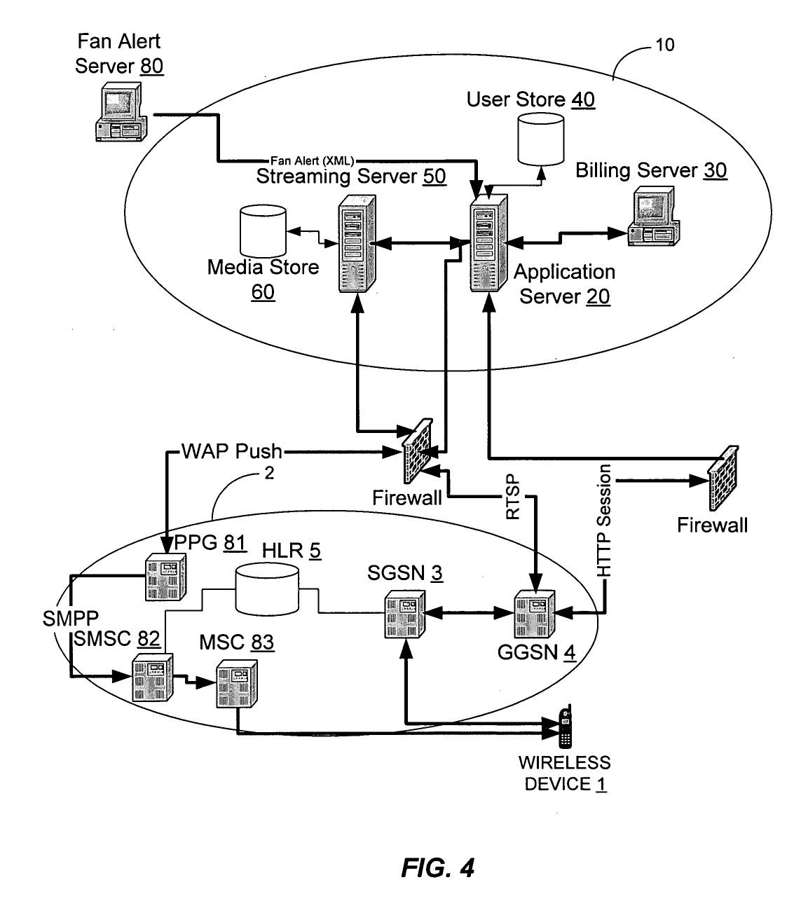

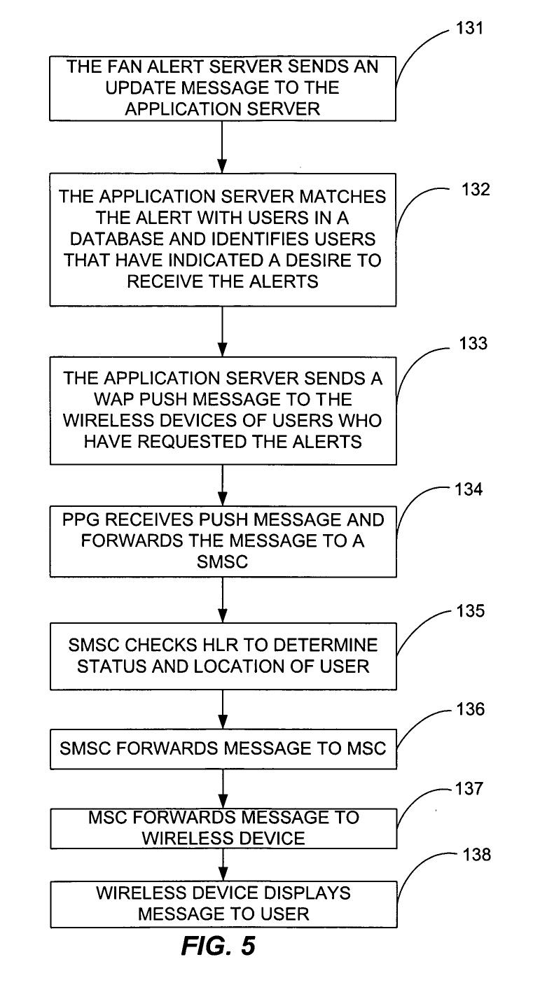

FIG. 4 illustrates a block diagram of the wireless device 1 of the invention and the system 10 of the invention, wherein the application server 20 further includes functionality for receiving and processing a fan alert. FIG. 5 illustrates a flow chart that represents the method of the invention in accordance with another embodiment for handling fan alerts. The manner in which the system 10 and the wireless network 2 cooperate to handle the fan alerts will be described with reference to FIGS. 4 and 5.

A fan alert is a message that is sent by a server 80, which may be outside of the system 10, to the application server 20 and typically includes a hyperlink to information about a selected artist or band, such as when a new album has just been released, for example. The fan alert server 80 sends an update message to the application server 20, as indicated by block 131. The update message is typically in a markup language (e.g., XML) format. The application server 20 performs an algorithm that attempts to match the alert with a database of the application server 20 in order to identify subscribers who have requested alerts, as indicated by block 132.

The application server 20 then sends a Wireless Application Protocol (WAP) push message to the wireless devices that have requested to receive such alerts, as indicated by block 133. The push message preferably includes a reference to the actual alert. A Push Proxy Gateway (PPG) 81 receives the push message content and delivery instructions and forwards them via a Short Message Peer-to-Peer Protocol (SMPP) to a Short Message Service Center (SMSC) 82, as indicated by block 134. The SMSC checks the home location register (HLR) to determine the status (e.g., active or inactive) of the user and the location of the user's wireless device, as indicated by block 135. Once the SMSC 82 has this information, it forwards the alert message and the user information to the Mobile Switching Center (MSC) 83, as indicated by block 136. The MSC 83 forwards the message to the wireless device 1, as indicated by block 137.

The streaming player of the wireless device 1 displays the alert, as indicated by block 138. When the wireless device 1 displays the alert, the user preferably is provided with an option to open a link contained in the alert, which may link (via the microbrowser of the wireless device) the wireless device 1 to additional media that are linked to the alert. Alternatively, the wireless device 1 may automatically open the link. The user may then add additional music selections to the user's playlist by making appropriate selections using the microbrowser.

It should be noted that the invention is not limited to the embodiments described above with reference to FIGS. 1-5. Modifications may be made to the embodiments described herein and all such modifications are within the scope of the invention. For example, particular tasks have been described as being performed by particular network elements. The invention is not limited to particular tasks being performed by particular network elements. Other modifications may be made to the embodiments described herein and all such modifications are within the scope of the invention.

What is claimed is:

1. A system for streaming music selections to a wireless device for playback on the wireless device, the system comprising:
a media storage database for storing music selections in a network;
request receiving logic configured to receive a request sent by a wireless device;
selection retrieving logic configured to retrieve music selections from the media storage database; and
music streaming logic configured to stream a music selection retrieved from the storage element to a wireless device that sent a request to play the music selection to the system.

2. The system of claim 1, further comprising:
authentication logic configured to determine whether or not a user associated with the request is authorized to receive the requested music selection.

3. The system of claim 1, wherein the authentication logic determines whether or not a user associated with a request is authorized to receive the requested music selection by determining whether or not the user has subscribed to a service that provides streaming music selections.

4. The system of claim 1, wherein the authentication logic determines whether or not a user is authorized to receive the requested music selection by determining whether or not the user has obtained digital rights associated with the requested music selection.

5. The system of claim 2, further comprising:
a user storage database for storing playlists, each playlist being associated with a respective subscriber to the system, each subscriber being associated with a respective wireless device, each playlist corresponding to a list of music selections that the corresponding subscriber has created, wherein the request receiving logic is configured to retrieve a playlist from the user storage database and to send the playlist to the corresponding wireless device upon receiving a playlist request from the corresponding wireless device.

6. The system of claim 5, further comprising:
billing logic configured to create and maintain billing records, each billing record being associated with a respective user of the system, each billing record including a fee that the corresponding user is charged for a subscription to the system, and wherein the authentication logic determines whether or not a user associated with a request is authorized to receive the requested music selection by determining whether or not the user has subscribed to a service that provides streaming music selections.

7. The system of claim 5, wherein the media storage database has an Internet Protocol (IP) address.

8. The system of claim 7, wherein the selection retrieving logic and music streaming logic correspond to a processor of a streaming server programmed with software to perform selection retrieving and streaming tasks, the streaming server having an IP address.

9. The system of claim 2, wherein the request receiving logic is configured to receive a fan alert request and to forward fan alerts to wireless devices of subscribers who have requested to receive fan alerts.

10. The system of claim 1, wherein the wireless device is a wireless telephone.

11. A method for storing music selections in a media storage database of a network and for streaming music selections to wireless devices of users upon request, the method comprising:
receiving a request to play a music selection in a component of the network, the request originating from a wireless device;
authenticating the request; and
if the request is authenticated, retrieving the requested music selection from the network media storage database and streaming the retrieved music selection to the wireless device that originated the request.

12. The method of claim 11, wherein authenticating the request is performed by determining whether or not a user associated with the request is a subscriber to a service that provides streaming music selections.

13. The method of claim 11, wherein authenticating the request is performed by determining whether or not the user has obtained digital rights associated with the requested music selection.

14. The method of claim 11, wherein the network is the Internet and wherein the network components and the network media storage database all have Internet Protocol (IP) addresses.

15. A computer program that controls a process of storing music selections in a media storage database of a network and of streaming music selections to wireless devices of users upon request, the computer program being embodied on a computer-readable medium, the program comprising:
a first code segment that receives a request to play a music selection in a component of the network, the request originating from a wireless device;
a second code segment that authenticates the request; and
a third code segment, wherein if the second code segment authenticates the request, the third code segment causes a request to be sent to the network media storage database to retrieve the requested music selection and stream the retrieved music selection to the wireless device that originated the request.

16. The computer program of claim 15, wherein the second code segment authenticates the request by determining whether or not a user associated with the request is a subscriber to a service that provides streaming music selections.

17. The method of claim 15, wherein the second code segment authenticates the request by determining whether or not the user has obtained digital rights associated with the requested music selection.
